(19) United States
(12) Patent Application Publication
(10) Pub. No.: US 2001/0006014 A1
(43) Pub. Date: Jul. 5, 2001

(54) COMBINATION DRIVING TOOL

(76) Inventors: G. STEPHEN COWART, MT. PLEASANT, SC (US); THOMAS P. BECKMANN, SUMMERVILLE, SC (US)

Correspondence Address: AMERICAN STANDARD INC, ONE CENTENNIAL AVENUE, PISCATAWAY, NJ, 08855

(21) Appl. No.: 09/226,352

(22) Filed: Jan. 6, 1999

(51) Int. Cl. B25F 1/00

(52) U.S. Cl. 81/437

(57) ABSTRACT

In one preferred embodiment, the present invention relates to a driving tool for use in driving at least two drivable objects, including a first drivable object and a second drivable object. The tool includes: a tubular body having an inner surface defining a longitudinal bore which includes a front socket portion adapted to drive the first drivable object; a retractable bit disposed within the longitudinal bore, the bit being axially, non-rotatably movable within the longitudinal bore, and the bit having a tip portion adapted to drive the second drivable object; a spring disposed in the longitudinal bore behind the retractable bit for forwardly biasing the bit; and a cap removably disposed on the rear of the tubular body, the cap closing the rear of the longitudinal bore and supporting the rear of the spring. Thus, the retractable bit is removably disposed in the longitudinal bore. The retractable bit is capable of being moved rearwardly into the longitudinal bore by contact with the first drivable object when the front socket portion engages the first drivable object, such that the tip portion is disposed rearwardly of at least a part of the front socket portion in a retracted state.

### FIELD OF THE INVENTION

The present invention relates to driving tools generally and, more particularly, but not by way of limitation, to a novel combination driving tool.

### BACKGROUND OF THE INVENTION

The present invention concerns driving tools in general, and in particular driving tools which impart torque to a driven element or drivable object such as bolts, screws, nuts, fasteners and the like.

Known driving tools, such as wrenches, screwdrivers, and the like, typically possess a driving head which is suited to drive a single type of driven element. For example, a socket wrench is adapted to engage a driven element, such as a bolt or nut, which has a head with a peripheral socket receiving configuration. On the other hand, other known driving tools may be suited to engage a driven element which has a head with a bit receiving configuration, such as a screw head with a single or cross slot configuration.

During a manufacturing process, it may be desirable to apply torque to a plurality of different driven elements which are located in a given locus. However, the act of changing tools to accommodate various driven elements requires time and effort, which leads to a concomitant increase in production cost. Even if the torque application phase of the manufacturing process were automated, a change in the tool or tool head results in an undesirable consumption of time and energy and requires additional process complexity. It would be desirable for a driving tool to be able to rapidly apply torque to more than one type of fastener with a minimum of effort.

Thus, a principal object of the present invention is to provide a single tool which can drive various elements with a minimum of movement, intervention and/or time consumption.

Another object is to provide a tool which is useful in automated processes.

Yet another object is to provide a tool having removable or interchangeable bits.

Still another object is to provide a tool which can incorporate both male and female driving capabilities.

Other objects of the present invention, as well as particular features, elements, and advantages thereof, will be elucidated in, or be apparent from, the following description and the accompanying drawing figures.

### SUMMARY OF THE INVENTION

The present invention achieves the above objects, among others, by providing the following.

In one aspect, the present invention relates to a driving tool comprising a tubular body, a retractable driving member, biasing means, and cap means. The tubular body has an inner surface defining a longitudinal bore and including a front socket portion. The retractable driving member is slidably disposed within the longitudinal bore, wherein the retractable driving member is substantially prevented from rotating relative to the tubular body, thereby allowing the tubular body to transmit torque to the retractable driving member. The biasing means forwardly biases the retractable driving member with respect to the tubular body. The cap means is removably coupled to the rear of the tubular body and provides access to the biasing means and the retractable driving member. The retractable driving member normally extends beyond the front socket portion, and the retractable driving member is capable of retracting into the longitudinal bore against the forward bias. Thus, the tool is capable of transmitting torque through at least one of the front socket portion and the retractable driving member.

The driving tool also preferably includes limiting means disposed on the inner surface of the tubular body for limiting the forward travel of the retractable driving member relative to the tubular body.

At least part of the inner surface of the tubular body engages at least part of the retractable driving member, thereby substantially preventing relative rotation between the tubular body and the retractable driving member, whereby torque is capable of being transmitted therebetween.

In a particularly preferred embodiment, the front socket portion is wider than the longitudinal bore. Furthermore, the inner surface of the tubular body further comprises a shoulder which defines the rear of the front socket portion.

In a highly preferred embodiment, the retractable driving member is removably disposed in the tubular body.

In a particularly preferred embodiment, the biasing means comprises a spring disposed in the longitudinal bore behind the retractable driving member. The front of the spring then abuts the rear of the retractable driving member, and the rear of the spring abuts the front of the cap.

The retractable driving member preferably comprises a forward-facing shoulder which engages the limiting means when the retractable driving member is fully extended.

In a particularly preferred embodiment, the limiting means comprises a retaining ring disposed on the inner surface of the tubular body, the ring extending radially into the longitudinal bore for engaging the forward-facing shoulder of the retractable driving member. The inner surface of the tubular body may include a recess for accommodating the retaining ring. In a particular embodiment, the recess is annular.

The tip of the retractable driving member may be either male or female.

The tool may also include a torquing attachment means disposed at the rear of the tubular body for facilitating connection to a torque driving tool.

In another aspect, the present invention relates to a driving tool for use in driving at least two drivable objects, including a first drivable object and a second drivable object. The tool comprises: a tubular body having an inner surface defining a longitudinal bore and including a front socket portion adapted to drive the first drivable object; a retractable bit disposed within the longitudinal bore, the bit being axially, non-rotatably movable within the longitudinal bore, the bit having a tip portion adapted to drive the second drivable object; a spring disposed in the longitudinal bore behind the retractable bit for forwardly biasing the bit; and a cap removably disposed on the rear of the tubular body, the cap closing the rear of the longitudinal bore and supporting the rear of the spring. Thus, the retractable bit is removably disposed in the longitudinal bore. The retractable bit is capable of being moved rearwardly into the longitudinal bore by contact with the first drivable object when the front socket portion engages the first drivable object, such that the tip portion is disposed rearwardly of at least a part of the front socket portion in a retracted state. Thus, the tool is capable of transmitting torque to the first drivable object when the bit is at least partially retracted. The tool may also transmit torque to the second drivable object when the bit is extended.

Preferably, the tip portion of the bit protrudes beyond the front socket portion in an extended state. The driving tool also preferably includes a stop disposed on the inner surface of the tubular body for limiting the forward travel of the retractable bit, wherein the bit protrudes beyond the front socket portion when the bit engages the stop.

In yet another aspect, the driving tool comprises a tubular body, a retractable bit, biasing means for biasing the bit toward the front of the tubular body, and limiting means for limiting the forward travel of the bit. The tubular body has an inner surface defining a longitudinal bore and including a front socket portion and a middle portion. The retractable bit is disposed within the longitudinal bore and is slidably movable therein. The bit includes a tip portion and a base portion. The base portion has an outer surface which slidably and non-rotatably mates with the middle portion of the tubular body, thereby substantially preventing relative rotation between the retractable bit and the tubular body and allowing the base portion to slide freely within the middle portion of the longitudinal bore. The limiting means is disposed on the inner surface of the tubular body and limits the forward travel of the bit within the longitudinal bore. The tip portion of the bit normally protrudes beyond the front socket portion, wherein the retractable bit is capable of being moved rearwardly into the longitudinal bore such that the tip portion is disposed rearwardly of at least a part of the socket portion. Thus, the tool is capable of transmitting torque through the tubular body and the retractable driving member.

In a particularly preferred embodiment, the front socket portion is wider than the middle portion.

In a preferred embodiment, the middle portion of the tubular body and the base portion of the bit have mating polygonal cross-sections.

In still another aspect, the present invention relates to a driving tool kit for transmitting torque to a first driven element and at least one other driven element. The kit comprises: a tubular body having a front socket portion adapted to drive the first driven element; a plurality of interchangeable retractable driving members, each of the interchangeable retractable driving members having a tip portion and a common mounting portion, wherein each respective tip portion is adapted to drive a respective driven element, and wherein each retractable driving member is capable of being slidably, non-rotatably, and removably disposed within the tubular body; and biasing means for forwardly biasing the retractable driving member with respect to the tubular body. Each retractable driving member is capable of at least partially retracting into the tubular body to allow the front socket portion to engage the first driven element. Each retractable driving member also normally extends beyond the front socket portion when disposed in the tubular body to engage a respective other driven element. Thus, each of the driving members is capable of being interchangeably mounted in the tubular body.

In yet another aspect, the present invention relates to a combination of a driving tool and first and second driven elements in which the first driven element includes a head with a peripheral socket receiving configuration, and the second driven element includes a head with a bit receiving configuration. The driving tool includes: a tubular body having an inner surface which defines a longitudinal bore and which includes a front socket portion and a middle portion, the front socket portion being adapted to engage the head of the first driven element; a retractable bit having a rear portion which is slidably and non-rotatably disposed within the middle portion of the tubular body, and a tip portion adapted to engage the second driven element, the retractable bit normally extending beyond the front socket portion to a forwardmost position, the retractable bit being capable of at least partially retracting into the tubular body; biasing means for forwardly biasing the retractable bit with respect to the tubular body; and cap means removably coupled to the rear of the tubular body for providing access to the biasing means and the retractable bit.

### BRIEF DESCRIPTION OF THE DRAWINGS

Understanding of the present invention and the various aspects thereof will be facilitated by reference to the accompanying drawing figures, submitted for purposes of illustration only and not intended to limit the scope of the invention, in which:

FIG. 1 is a partial cutaway view of a driving tool in accordance with one embodiment of the present invention with the retractable driving member in a fully extended position; and

FIG. 2 is a partial cutaway view of the driving tool of FIG. 1 shown in a fully retracted position with a drivable element shown in broken lines.

### DETAILED DESCRIPTION OF THE PREFERRED EMBODIMENTS

Reference should now be made to the drawing figures, on which similar or identical elements are given consistent identifying numerals throughout the various figures thereof, and on which parenthetical references to figure numbers direct the reader to the view(s) on which the element(s) being described is (are) best seen, although the element(s) may also be seen on other views.

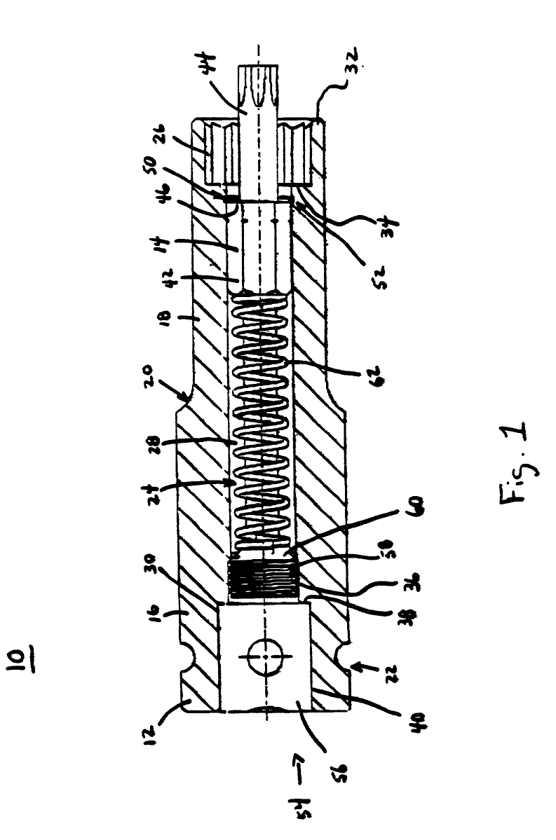

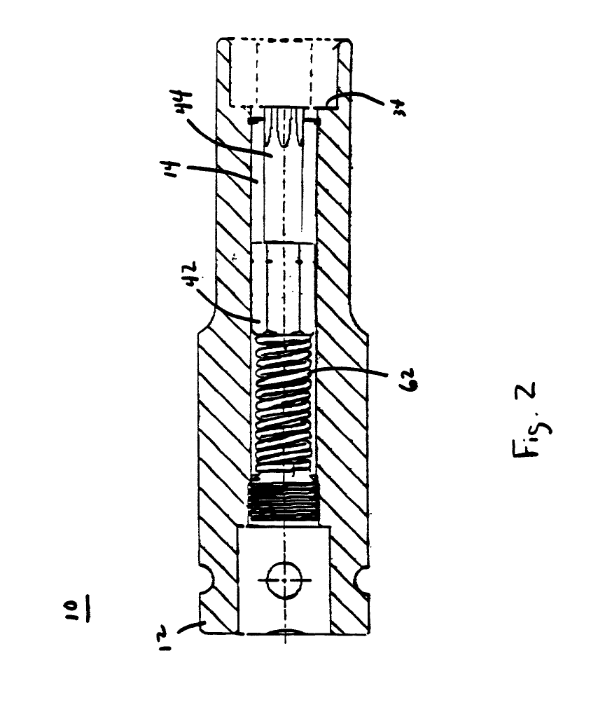

Referring to FIGS. 1 and 2, one preferred embodiment of the present invention relates to a driving tool 10 which includes a tubular body 12 and a retractable driving member 14.

The tubular body 12 is rigid and preferably of unitary construction. Preferably, the tubular body 12 has a rear section 16 of greater diameter smoothly transitioning into a front section 18 of lesser diameter along a radius 20. The rear section 16 can be gripped and/or otherwise coupled to a torque driver, torque may be applied to the tool 10 at the rear section 16, and the tool 10 may transmit the torque to a driven element through the front section 18. The greater diameter of the rear section 16 provides a sturdy mount for the tool 10. The lesser diameter front section 18 also allows the front of the tool to engage the head of a drivable object, e.g. a fastener such as a nut, which may be recessed recessed in a tight bore. An annular recess 22 is disposed on the outside surface of the rear section 16 to facilitate coupling the tool 10 to a torque driver, although other means of torque connection can be provided on the rear section 16 of the body 12 as known by the skilled artisan.

A longitudinal bore 24 extends throughout the tubular body 12 whose inner surface includes a front socket portion 26, a middle portion 28, and a capping or retaining portion 30.

In the embodiment shown in FIGS. 1-2, the front socket portion 26 is preferably of greater diameter than the middle portion 28. An inwardly flared lip 32 of the body 12 preferably defines the leading edge of the tool 10 to facilitate entry of the drivable element and to provide a relatively smooth surface so as to avoid damaging the drivable element or item to be torqued. The distal tip of the leading edge may be preferably rounded or smoothed so as to minimize possible alteration or damage to the area surrounding the drivable element of interest. A shoulder 34 on the inner surface of the body 12 defines the rear of the front socket portion 26. The resulting “step” may help to prevent the tool 10 from “bottoming out” in instances where the leading edge of the tool might otherwise contact a surface or an object which is, for example, not part of the drivable object of interest. It should be noted that in order to transmit the necessary torque it may be sufficient for the tool 10 to engage only a portion of the head of a drivable object of interest. Thus, in at least one preferred embodiment, it may be advantageous for the drivable element to engage the shoulder 26 while the leading edge of the tool 10 does not extend beyond the head of the drivable element, thereby minimizing contact with, for example, the surface of an object in which the drivable element is to be mounted or in which the drivable element is already mounted. The middle portion 28 is represented in FIGS. 1 and 2 by the hexagonal sides of the inner surface of the tubular body 12. In general, the inner surface of the body 12 forming the middle portion 28 is preferably polygonal, although other configurations, such as a lobed configuration, can also be used. The inner surface of the body 12 which forms the capping portion 30 is shown to have a threaded section 36, a rearwardly-facing shoulder 38 and a cap receiving section 40.

A retractable driving member or retractable bit 14 is movably disposed in the longitudinal bore 24. The bit 14 has a base portion 42 and a tip portion 44. The tip portion 44 has a lesser diameter than the base portion 42 for reasons which will become apparent below. A forward facing shoulder 46 delimits the base portion 42 and the tip portion 44. The base portion 42 has an outer surface which mates with the inner surface of the body 12 in the middle portion 28 of the bore 24 such that the bit 14 is free to slide axially in the bore 24 while being substantially prevented from rotating with respect to the body 12. For example, the outer surface of the base portion 42 and the inner surface of the body 12 at the middle portion 28 may have matching polygonal shapes or cross-sections. In the embodiment shown in FIGS. 1-2, the base portion 42 and the middle portion 28 have mating hexagonal shapes. Preferably, the base portion 42 of the bit 14 rests snugly enough in the bore 24 to minimize any rotational displacements therebetween upon the application of torque thereto, but also should fit within the body 12 in a manner which minimizes frictional resistance to the bit 14 while sliding within the bore 24.

A limiting means 50 such as a stop is disposed on the inner surface of the body 12 so as to project radially into the bore 24 while allowing the tip portion 44 of the bit 14 to freely slide therepast. The stop 50 extends into the bore 24 sufficiently to engage the forward facing shoulder 46 of the bit 14, thereby establishing a maximum forwardmost linear displacement of the bit 14 with respect to the body 12. In the embodiment shown in FIGS. 1-2, a recess 52 is provided in the inner surface of the body 12, and the limiting means 50 is shown to be a retaining ring which is disposed partially within the recess 52 and partially extending into the bore 24. As shown in FIG. 1, when the bit 14 is fully extended with respect to the body 12, its forward facing shoulder 46 engages the limiting means or retaining ring 50, and its tip portion 44 preferably extends beyond the front edge of the body 12.

The rear of the longitudinal bore 24 is closed off by a cap means 54. Preferably, the cap means 54 is removably attached to the body 12. As shown in the Figure, a cap 56 is removably coupled to the body 12. The cap 56 has a threaded portion 58 and a conical tip 60. The threaded portion 56 mates with the threaded section 36 of the body 12.

A biasing means 62 is disposed inside the body 12 for biasing the retractable driving member or retractable bit 14 in a forward direction. In the embodiment shown in FIGS. 1-2, a spring 62 is positioned in the bore 24 behind the retractable bit 14.

The conical tip 60 of the cap 56 provides a means for aligning or centering the rear end of the spring and provides a fixed support for the spring. Importantly, the cap 56 provides easy access to the spring 62 and the bit 14, wherein the spring 62 and/or the bit 14 can be maintained or interchanged.

Thus, a single body 12 may be coupled with any one of a variety of interchangeable bits 14. Furthermore, springs of various strengths and other properties may be inserted into the tool 10 for particular applications. In a particular embodiment, the compression of the spring member can be selectively adjusted by displacement of the cap 56.

When the cap 56 is inserted into the body 12, the spring 62 is compressed and exerts a forward bias to the bit 14. Preferably, the diameter of the spring 62 has characteristics sufficient to prevent kinking or unwanted deformation during compression thereof. For example, if a diameter of the bore 24 were too large in comparison to the diameter of the spring 62, then the spring 62 may tend to buckle, leading to an undesirable result. Furthermore, the compressive strength of the spring 62 should permit retraction of the bit 14 within the bore 24 upon application of an expected axial force or load.

In order to assemble the tool 10, a retractable bit 14 is inserted, tip first, into the rear of the tubular body 12, followed by a spring 62. The cap 56 is then screwed into the back of the body 12, thereby compressing the spring 62 and forwardly biasing the bit 14 such that the forward facing shoulder 46 of the bit 14 engages the retainer ring 50 and the tip portion 44 of the bit 14 extends beyond the front edge of the body 12.

The tool 10 may then be attached to a torque driver by attaching the rear section 16 of the body 12 thereto.

In use, the tool 10 is brought into contact with a drivable element, such as a bolt, nut, screw, etc., so that either the front socket portion 26 of the body 12 or the tip portion 44 of the bit 14 engages the drivable element. Torque is then applied to the tool 10 and transmitted to the drivable element.

The front socket portion 26 of the tool 10 is preferably adapted to engage a drivable element having a peripheral socket receiving configuration. Thus, the front socket portion 26 is female. For example, the drivable element may have a polygonal head configuration. Furthermore, the drivable element and the mating configuration of the front socket portion 26 can be symmetric or asymmetric. As the front socket portion 26 of the tool 10 is brought into contact with the drivable element, the bit 14 is pushed backward into the longitudinal bore 24 against the bias of the spring 62. As illustrated in FIG. 2, the bit 14 may fully retreat into the bore 24 until the end of the tip portion 44 is flush or nearly flush with the shoulder 34 of the front socket portion 26.

FIG. 2 shows a representative drivable element, in broken lines, contacting the tip portion 44 of the bit 14. It should be understood that FIG. 2 illustrates only one of many different types of drivable elements which can be engaged by the tool 10 of the present invention.

Thus, the end of the drivable element may come to rest upon the shoulder 34, thereby limiting its travel into the bore 24. Of course, the tool 10 may drive a drivable element whose head may be of such a configuration and/or size that the head does not fully extend into the front socket portion 26, whereupon the bit 14 is only partially retracted into the bore 24 during torque transfer. Furthermore, if the drivable element itself has an open center bore, the front socket portion 26 may engage the periphery of the driven element while the bit 14 may extend through the bore of the drivable element.

The tip portion 44 of the bit 14 preferably extends beyond the front socket 26 portion to facilitate alignment with its respective drivable element, to permit rapid engagement between the bit and the element, and, in some applications, to allow the tool 10 to transfer torque to an element whose diameter exceeds the diameter of the front socket portion. Of course, if the maximum diameter of the drivable element to be engaged by the bit 14 is smaller than the smallest inside diameter of the front socket portion 26, then the tip 44 may be partially retracted into the bore 24 while still engaging the drivable element.

In other embodiments, the bit 14 and the front socket portion 26 may both be used to drive a single driven element.

The tip portion 44 of the bit 14 may be male or female.

The tool 10 may be advantageously used in automated processes and powered tool systems. In one preferred embodiment, the tool 10 is implemented in a pneumatic driver, wherein the driver engages a plurality of drivable elements of two types in succession, each type of drivable element being driven by either the bit 14 or the front socket portion 26. In a particular embodiment, the driver successively engages the plurality of drivable elements in a fixed pattern.

The tool 10 may also be used in manual operations, wherein the tool may be attached to a handle which, for example, may enclose at least part of the rear section 16 of the body 12.

As the cap 54 means facilitates rapid changes of the retractable bit 14, another aspect of the present invention relates to a driving tool kit for transmitting torque to a first driven element and at least one other driven element. The kit may include a tubular body 12 having a front socket portion 26 adapted to drive the first driven element and a plurality of interchangeable retractable driving members 14, each of the interchangeable retractable driving members 14 having a tip portion 44 and a common mounting portion 42, wherein each respective tip portion 44 is adapted to drive a respective driven element, wherein each retractable driving member 14 is capable of being slidably, non-rotatably, and removably disposed within the tubular body 12. The kit may also include a plurality of tubular bodies 10 with one or more interchangeable retractable driving members 14, with each driving member being compatible with one or more of the tubular bodies. Furthermore, the kit may also include a plurality of springs 62 for biasing the respective bits 14 within a respective tubular body 12, wherein each spring is compatible with one or more of the tubular bodies. The plurality of springs 62 may include springs of a variety of sizes, compressive strengths, etc. to be matched to a particular application. Likewise, the tubular bodies and the bits 14 may be adapted to accommodate a variety of drivable objects, for example of various sizes and/or head configurations.

It should be understood that the retractable bit or retractable driving member 14 can be male or female. For example, a male bit could have a tip portion in the configuration of a single slot, multiple slots, cross slot or Phillips® head, lobed or Torx® head, hexagonal or Allen® head, or any of a multitude of configurations, without limitation. Typically such head configurations are symmetrical, although the present invention can accommodate asymmetrical configurations as well. Similarly, the female bit could have any of an unlimited variety of tip portions, whether symmetrical or asymmetrical.

It will thus be seen that the objects set forth above, among those elucidated in, or made apparent from, the preceding description, are efficiently attained and, since certain changes may be made in the above construction without departing from the scope of the invention, it is intended that all matter contained in the above description or shown on the accompanying drawing figures shall be interpreted as illustrative only and not in a limiting sense.

It is also to be understood that the following claims are intended to cover all of the generic and specific features of the invention herein described and all statements of the scope of the invention which, as a matter of language, might be said to fall therebetween.

1. A driving tool comprising:
a tubular body having an inner surface defining a longitudinal bore which includes a front socket portion;
a retractable driving member slidably disposed within said longitudinal bore, wherein said retractable driving member is substantially prevented from rotating relative to said tubular body;
biasing means for forwardly biasing said retractable driving member with respect to said tubular body; and
cap means removably coupled to the rear of said tubular body for providing access to said biasing means and said retractable driving member;
wherein said retractable driving member normally extends beyond said front socket portion.

2. The driving tool according to claim 1 further comprising limiting means disposed on the inner surface of said tubular body for limiting the forward travel of said retractable driving member relative to said tubular body.

3. The driving tool according to claim 1 wherein said front socket portion is wider than said longitudinal bore.

4. The driving tool according to claim 1 wherein the inner surface of said tubular body further comprises a shoulder which defines the rear of said front socket portion.

5. The driving tool according to claim 1 wherein said retractable driving member is removably disposed in said tubular body.

6. The driving tool according to claim 1 wherein said biasing means comprises a spring disposed in said longitudinal bore behind said retractable driving member.

7. The driving tool according to claim 1 wherein said retractable driving member comprises a forward-facing shoulder which engages said limiting means when said retractable driving member is fully extended.

8. The driving tool according to claim 7 wherein said limiting means comprises a retaining ring disposed on the inner surface of said tubular body, said ring extending radially into said longitudinal bore for engaging said forward-facing shoulder of said retractable driving member.

9. The driving tool according to claim 8 wherein the inner surface of said tubular body further comprises a recess for accommodating said retaining ring.

10. The driving tool according to claim 1 wherein the tip of said retractable driving member is male.

11. The driving tool according to claim 1 wherein the tip of said retractable driving member is female.

12. A driving tool for use in driving at least two drivable objects, including a first drivable object and a second drivable object, said tool comprising:
a tubular body having an inner surface defining a longitudinal bore which includes a front socket portion adapted to drive the first drivable object;
a retractable bit disposed within said longitudinal bore, said bit being axially, non-rotatably movable within said longitudinal bore, said bit having a tip portion adapted to drive the second drivable object;
a spring disposed in said longitudinal bore behind said retractable bit for forwardly biasing said bit; and
a cap removably disposed on the rear of said tubular body, said cap closing the rear of said longitudinal bore and supporting the rear of said spring;
wherein said retractable bit is capable of being moved rearwardly into the longitudinal bore by contact with the first drivable object when said front socket portion engages the first drivable object, such that the tip portion is disposed rearwardly of at least a part of said front socket portion in a retracted state.

13. The driving tool according to claim 12 wherein the tip portion of said bit protrudes beyond said front socket portion in an extended state.

14. The driving tool according to claim 12 further comprising a stop disposed on said inner surface of said tubular body for limiting the forward travel of said retractable bit.

15. A driving tool comprising:
a tubular body having an inner surface defining a longitudinal bore which includes a front socket portion and a middle portion;
a retractable bit disposed within said longitudinal bore and slidably movable therein, said bit including:
a tip portion, and
a base portion having an outer surface which slidably and non-rotatably mates with the middle portion of said tubular body, thereby substantially preventing relative rotation between said retractable bit and said tubular body and allowing said base portion to slide freely within said middle portion of said longitudinal bore;
biasing means for biasing said bit toward the front of said tubular body; and
limiting means disposed on said inner surface of said tubular body for limiting the forward travel of said bit within said longitudinal bore;
wherein said tip portion normally protrudes beyond said front socket portion;
wherein said retractable bit is capable of being moved rearwardly into the longitudinal bore such that the tip portion is disposed rearwardly of at least a part of said socket portion;
whereby said tool is capable of transmitting torque through said tubular body and said retractable driving member.

16. The driving tool according to claim 15 wherein said front socket portion is wider than said middle portion.

17. The driving tool according to claim 15 wherein said middle portion of said tubular body and said base portion of said bit have mating polygonal cross-sections.

18. A driving tool kit for transmitting torque to a first driven element and at least one other driven element, said kit comprising:
a tubular body having a front socket portion adapted to drive the first driven element;
a plurality of interchangeable retractable driving members, each of said interchangeable retractable driving members having a tip portion and a common mounting portion, wherein each respective said tip portion is adapted to drive a respective driven element, and wherein each said retractable driving member is capable of being slidably, non-rotatably, and removably disposed within said tubular body; and
biasing means for forwardly biasing said retractable driving member with respect to said tubular body;
wherein each said retractable driving member is capable of at least partially retracting into said tubular body to allow said front socket portion to engage the first driven element; and
wherein each said retractable driving member normally extends beyond said front socket portion when disposed in said tubular body to engage a respective other driven element.

19. The combination of a driving tool and first and second driven elements in which:
said first driven element includes a head with a peripheral socket receiving configuration;
said second driven element includes a head with a bit receiving configuration; and
said driving tool includes:
a tubular body having an inner surface which defines a longitudinal bore which includes a front socket portion and a middle portion, said front socket portion being adapted to engage said head of said first driven element;
a retractable bit having a rear portion which is slidably and non-rotatably disposed within said middle portion of said tubular body, and a tip portion adapted to engage said second driven element, said retractable bit normally extending beyond said front socket portion to a forwardmost position, said retractable bit being capable of at least partially retracting into said tubular body;
biasing means for forwardly biasing said retractable bit with respect to said tubular body; and
cap means removably coupled to the rear of said tubular body for providing access to said biasing means and said retractable bit.
